(19) United States
(12) Patent Application Publication
(10) Pub. No.: US 2026/0214234 A1
(43) Pub. Date: Jul. 23, 2026

(54) Overlapped Prediction In Video Coding

(71) Applicant: Google LLC, Mountain View, CA (US)

(72) Inventors: Xiang Li, Saratoga, CA (US); Yaowu Xu, Saratoga, CA (US); Jingning Han, Santa Clara, CA (US); Debargha Mukherjee, Cupertino, CA (US)

(21) Appl. No.: 19/140,122

(22) PCT Filed: Dec. 11, 2023
(86) PCT No.: PCT/US2023/083415

§ 371 Date: Jun. 17, 2025

Related U.S. Application Data
(60) Provisional application No. 63/434,991, filed on Dec. 23, 2022.
(60) Provisional application No. 63/480,262, filed on Jan. 17, 2023.

(51) Int. Cl. H04N 19/137; H04N 19/105; H04N 19/176

(52) U.S. Cl. CPC H04N 19/137; H04N 19/105; H04N 19/176

(57) ABSTRACT

Encoding and decoding a current block of a current frame is disclosed. A first prediction block for the current block is obtained based on motion information associated with the first prediction block. A second prediction block for at least a portion of the current block is obtained based on a motion information associated with a neighboring block. A prediction difference measure is obtained between the first prediction block and the second prediction block. The prediction difference measure is used to determine whether to combine the first prediction block and the second prediction block of the portion of the current block. The prediction difference measure can be a sum of absolute differences (SAD) between the first prediction block and the second prediction block. The prediction difference measure can be an absolute maximum of pair-wise differences between the first prediction block and the second prediction block.

### CROSS REFERENCES TO RELATED APPLICATIONS

This application claims the benefit of and priority to U.S. Provisional Patent Application Ser. No. 63/434,991, filed Dec. 23, 2022, and U.S. Provisional Patent Application Ser. No. 63/480,262, filed Jan. 17, 2023, the entire disclosures of which are incorporated herein by reference.

### BACKGROUND

Digital video can be used, for example, for remote business meetings via video conferencing, high definition video entertainment, video advertisements, or sharing of user-generated videos. Due to the large amount of data involved in video data, high performance compression is needed for transmission and storage. Various approaches have been proposed to reduce the amount of data in video streams, including compression and other encoding and decoding techniques.

### SUMMARY

This application relates to encoding and decoding of video stream data for transmission or storage. Disclosed herein are aspects of systems, methods, and apparatuses related to adaptive overlapped block prediction in variable block size video coding.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method for coding a current block of a current frame includes obtaining a first prediction block for the current block based on motion information associated with the first prediction block; obtaining a second prediction block for at least a portion of the current block based on a motion information associated with a neighboring block; obtaining a prediction difference measure between the first prediction block and the second prediction block; and determining, based on the prediction difference measure, whether to combine the first prediction block and the second prediction block of the portion of the current block. Implementations may further include one or more of the following features.

The method where determining, based on the prediction difference measure, whether to combine the first prediction block and the second prediction block of the portion of the current block may include determining not to combine the first prediction block and the second prediction block in response to the prediction difference measure exceeding a threshold. The method where the threshold can be a power of 2. The method where the prediction difference measure can be a sum of absolute differences (SAD) between the first prediction block and the second prediction block. The method where the prediction difference measure can be a sum of squared error (SSE) between the first prediction block and the second prediction block. The method where the prediction difference measure can be an absolute maximum of pair-wise differences between the first prediction block and the second prediction block.

The method where the prediction difference measure can be calculated based on at least one of a maximum absolute difference or an average absolute difference. The method where the maximum absolute difference can be an absolute maximum of pair-wise differences between the first prediction block and the second prediction block The method where the average absolute difference is an average of the pair-wise differences. The method where the prediction difference measure can be calculated as an absolute difference between the maximum absolute difference and the average absolute difference. The method where the prediction difference measure can be calculated based on a ratio of the maximum absolute difference to the average absolute difference.

The method may include determining to obtain the second prediction block in response to determining that a motion-vector difference between a first motion vector of the current block and a second motion vector of the neighboring block is smaller than a motion-vector threshold. The method may include determining to obtain the second prediction block in response to determining that first reference frames used for predicting the current block are at least partially the same as second reference frames used for predicting the neighboring block are the same. The method may include determining to obtain the second prediction block in response to determining that the current block is a block of a P frame or a P slice, that the current block and the neighboring block use the same reference frames, and that respective absolute motion vector differences between motion vectors of the current block and motion vectors of the neighboring block are below a motion-vector threshold.

In another general aspect, a method for coding a current block of a current frame includes obtaining a first prediction block for the current block based on a first reference frame and a first motion vector; determining, based at least in part on information related to a neighboring block of the current block, to obtain a second prediction block of at least a portion of the current block using an overlapped prediction mode that uses a second reference frame and a second motion vector of the neighboring block, where the second motion vector of the neighboring block is obtained by rounding, to an integer pixel position, a motion vector used to predict the neighboring block; obtaining the second prediction block using the overlapped prediction mode; and combining the first prediction block and the second prediction block. Implementations may further include one or more of the following features.

The method where determining, based at least in part on the information related to the neighboring block of the current block, to obtain the second prediction block of the portion of the current block using the overlapped prediction mode may include determining that a motion-vector difference between the first motion vector and the second motion vector is smaller than a motion-vector threshold. The method may include decoding, from a compressed bitstream, a one-frame-distance-motion-vector threshold; and calculating the motion-vector threshold based on the one-frame-distance-motion-vector threshold and a frame difference between the first reference frame and the second reference frame. The method where the motion-vector threshold can be proportional to a temporal distance between the first reference frame and the second reference frame.

The method may include, in response to determining that the first reference frame is different from the second reference frame, calculating a difference between the first motion vector and the second motion vector by the following steps. First, in response to determining that the current block is predicted using first motion vectors that include the first motion vector, obtaining scaled first motion vectors by scaling the first motion vectors to point to a target reference frame based on a temporal distance; and averaging the scaled first motion vectors to obtain a first normalized motion vector. Second, in response to determining that the neighboring block is predicted using second motion vectors that include the second motion vector, obtaining scaled second motion vectors by scaling the second motion vectors to point to the target reference frame; and averaging the scaled second motion vectors to obtain a second normalized motion vector. Third, calculating the motion-vector difference based on 1) one of the first normalized motion vector or the first motion vector and 2) one of the second normalized motion vector or the second motion vector.

The method where determining, based at least in part on the information related to the neighboring block of the current block, to obtain the second prediction block of the portion of the current block using the overlapped prediction mode can include determining that first reference frames used for predicting the current block are at least partially the same as second reference frames used for predicting the neighboring block are the same, wherein the first reference frames include the first reference frame and the second reference frames include the second reference frame, and wherein the first reference frame is the same as the second reference frame.

The method where determining, based at least in part on the information related to the neighboring block of the current block, to obtain the second prediction block of the portion of the current block using the overlapped prediction mode can include determining that reference samples used to obtain the second prediction block using a subpixel interpolation filter are available.

The method where determining, based at least in part on the information related to the neighboring block of the current block, to obtain the second prediction block of the portion of the current block using the overlapped prediction mode can include determining that the current block is a block of a P frame or a P slice, that the current block and the neighboring block use the same reference frames, and that respective absolute motion vector differences between motion vectors of the current block and motion vectors of the neighboring block are below a motion-vector threshold.

The method where the motion vector can be used to predict the neighboring block is rounded using at least one of rounding toward positive infinity, rounding towards negative infinity, or rounding towards zero. The method where a component of the motion vector can be rounded towards positive infinity in a case that the component is positive, and can be rounded towards negative infinity in a case that the component is negative.

Where the current block may be long a first boundary of a parent block, the method may include determining, in parallel with determining whether to obtain the second prediction block of the at least the portion of the current block using the overlapped prediction mode, whether to perform the overlapped prediction mode with respect to a second boundary of the parent block, wherein the second boundary is different from the first boundary.

Variations in these and other aspects will be described in additional detail hereafter. It will be appreciated that aspects can be implemented in any convenient form. For example, aspects may be implemented by appropriate computer programs which may be carried on appropriate carrier media which may be tangible carrier media (e.g., disks) or intangible carrier media (e.g., communications signals). Aspects may also be implemented using suitable apparatus which may take the form of programmable computers running computer programs arranged to implement the methods and/or techniques disclosed herein. Aspects can be combined such that features described in the context of one aspect may be implemented in another aspect.

### BRIEF DESCRIPTION OF THE DRAWINGS

The description herein makes reference to the accompanying drawings wherein like reference numerals refer to like parts throughout the several views, and wherein:

FIG. 1 is a diagram of a computing device in accordance with implementations of this disclosure.

FIG. 2 is a diagram of a computing and communications system in accordance with implementations of this disclosure.

FIG. 3 is a diagram of a video stream for use in encoding and decoding in accordance with implementations of this disclosure.

FIG. 4 is a block diagram of an encoder in accordance with implementations of this disclosure.

FIG. 5 is a block diagram of a decoder in accordance with implementations of this disclosure.

FIG. 6 is a flowchart diagram of an example process for adaptive overlapped block prediction in accordance with implementations of this disclosure.

FIG. 7 is a block diagram of an example block based prediction with variable block sizes in accordance with implementations of this disclosure.

FIG. 8 is a block diagram of example size variations of overlap regions in accordance with implementations of this disclosure.

FIG. 9 is a block diagram of an example weighted function for overlapped prediction in accordance with implementations of this disclosure.

FIG. 10 is a block diagram illustrating sub-block overlapped prediction.

FIG. 11 is a flowchart diagram of a technique for coding a current block of a video frame using overlapped prediction.

FIG. 12 is a flowchart diagram of another technique for coding a current block of a video frame using overlapped prediction.

### DETAILED DESCRIPTION

Video compression schemes may include breaking each image, or frame, into smaller portions, such as blocks, and generating an output bitstream using techniques to limit the information included for each block in the output. An encoded bitstream can be decoded to re-create the source images from the limited information. In some implementations, the information included for each block in the output may be limited by reducing spatial redundancy, reducing temporal redundancy, or a combination thereof. For example, temporal or spatial redundancies may be reduced by predicting a frame based on information available to both the encoder and decoder, and including information representing a difference, or residual, between the predicted frame and the original frame in an encoded video stream.

In some implementations, a frame may be divided into blocks of variable sizes, pixel values of each block may be predicted using previously coded information, and prediction parameters and residual data of each block may be encoded as output. A decoder may receive the prediction parameters and residual data in the compressed bitstream and may reconstruct the frame, which may include predicting blocks based on previously decoded image data.

Overlapped prediction is a kind of weighted prediction that can improve prediction of a block by using prediction information from adjacent blocks. A prediction from a current block and a prediction based on motion information from a neighboring block can be weighted to form a final prediction. When overlapped prediction is applied, at least some pixels (e.g., top and/or left pixels close the boundaries) of a current block can be refined using the motion information of one or more neighboring blocks.

In some implementations, the prediction block size of the adjacent blocks may vary among the adjacent blocks and may be different from the prediction block size of a current block. Respective overlap regions within the current block can be identified corresponding to respective adjacent blocks, and an overlapped prediction can be determined for respective overlap regions based on prediction parameters from the corresponding adjacent blocks. In some implementations, overlapped prediction may be optimized by adapting the size of each overlap region in the current block, such as according to a comparison of the prediction parameters of the adjacent block and the prediction parameters of the current block.

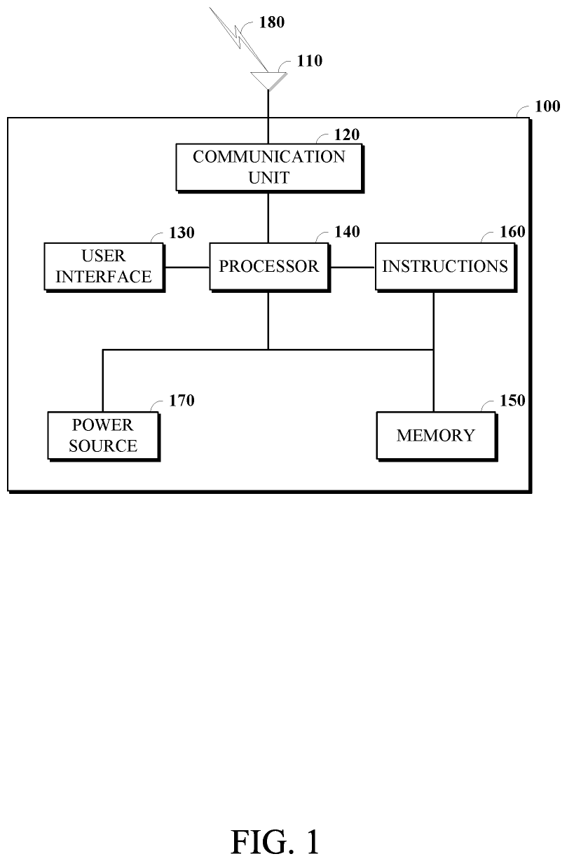

FIG. 1 is a diagram of a computing device 100 in accordance with implementations of this disclosure. A computing device 100 can include a communication interface 110, a communication unit 120, a user interface (UI) 130, a processor 140, a memory 150, instructions 160, a power source 170, or any combination thereof. As used herein, the term “computing device” includes any unit, or combination of units, capable of performing any technique, or any portion or portions thereof, disclosed herein.

The computing device 100 may be a stationary computing device, such as a personal computer (PC), a server, a workstation, a minicomputer, or a mainframe computer; or a mobile computing device, such as a mobile telephone, a personal digital assistant (PDA), a laptop, or a tablet PC. Although shown as a single unit, any one or more element of the computing device 100 can be integrated into any number of separate physical units. For example, the UI 130 and processor 140 can be integrated in a first physical unit and the memory 150 can be integrated in a second physical unit.

The communication interface 110 can be a wireless antenna, as shown, a wired communication port, such as an Ethernet port, an infrared port, a serial port, or any other wired or wireless unit capable of interfacing with a wired or wireless electronic communication medium 180.

The communication unit 120 can be configured to transmit or receive signals via the wired or wireless electronic communication medium 180. For example, as shown, the communication unit 120 is operatively connected to an antenna configured to communicate via wireless signals. Although not explicitly shown in FIG. 1, the communication unit 120 can be configured to transmit, receive, or both via any wired or wireless communication medium, such as radio frequency (RF), ultraviolet (UV), visible light, fiber optic, wire line, or a combination thereof. Although FIG. 1 shows a single communication unit 120 and a single communication interface 110, any number of communication units and any number of communication interfaces can be used.

The UI 130 can include any unit capable of interfacing with a user, such as a virtual or physical keypad, a touchpad, a display, a touch display, a speaker, a microphone, a video camera, a sensor, or any combination thereof. The UI 130 can be operatively coupled with the processor, as shown, or with any other element of the computing device 100, such as the power source 170. Although shown as a single unit, the UI 130 may include one or more physical units. For example, the UI 130 may include an audio interface for performing audio communication with a user, and a touch display for performing visual and touch based communication with the user. Although shown as separate units, the communication interface 110, the communication unit 120, and the UI 130, or portions thereof, may be configured as a combined unit. For example, the communication interface 110, the communication unit 120, and the UI 130 may be implemented as a communications port capable of interfacing with an external touchscreen device.

The processor 140 can include any device or system capable of manipulating or processing a signal or other information now-existing or hereafter developed, including optical processors, quantum processors, molecular processors, or a combination thereof. For example, the processor 140 can include a special purpose processor, a digital signal processor (DSP), a plurality of microprocessors, one or more microprocessor in association with a DSP core, a controller, a microcontroller, an Application Specific Integrated Circuit (ASIC), a Field Programmable Gate Array (FPGA), a programmable logic array, programmable logic controller, microcode, firmware, any type of integrated circuit (IC), a state machine, or any combination thereof. As used herein, the term “processor” includes a single processor or multiple processors. The processor can be operatively coupled with the communication interface 110, communication unit 120, the UI 130, the memory 150, the instructions 160, the power source 170, or any combination thereof.

The memory 150 can include any non-transitory computer-usable or computer-readable medium, such as any tangible device that can, for example, contain, store, communicate, or transport the instructions 160, or any information associated therewith, for use by or in connection with the processor 140. The non-transitory computer-usable or computer-readable medium can be, for example, a solid state drive, a memory card, removable media, a read only memory (ROM), a random access memory (RAM), any type of disk including a hard disk, a floppy disk, an optical disk, a magnetic or optical card, an application specific integrated circuits (ASICs), or any type of non-transitory media suitable for storing electronic information, or any combination thereof. The memory 150 can be connected to, for example, the processor 140 through, for example, a memory bus (not explicitly shown).

The instructions 160 can include directions for performing any technique, or any portion or portions thereof, disclosed herein. The instructions 160 can be realized in hardware, software, or any combination thereof. For example, the instructions 160 may be implemented as information stored in the memory 150, such as a computer program, which may be executed by the processor 140 to perform any of the respective techniques, algorithms, aspects, or combinations thereof, as described herein. The instructions 160, or a portion thereof, may be implemented as a special purpose processor, or circuitry, that can include specialized hardware for carrying out any of the techniques, algorithms, aspects, or combinations thereof, as described herein. Portions of the instructions 160 can be distributed across multiple processors on the same machine or different machines or across a network such as a local area network, a wide area network, the Internet, or a combination thereof.

The power source 170 can be any suitable device for powering the communication interface 110. For example, the power source 170 can include a wired power source; one or more dry cell batteries, such as nickel-cadmium (NiCd), nickel-zinc (NiZn), nickel metal hydride (NiMH), lithium-ion (Li-ion); solar cells; fuel cells; or any other device capable of powering the communication interface 110. The communication interface 110, the communication unit 120, the UI 130, the processor 140, the instructions 160, the memory 150, or any combination thereof, can be operatively coupled with the power source 170.

Although shown as separate elements, the communication interface 110, the communication unit 120, the UI 130, the processor 140, the instructions 160, the power source 170, the memory 150, or any combination thereof can be integrated in one or more electronic units, circuits, or chips.

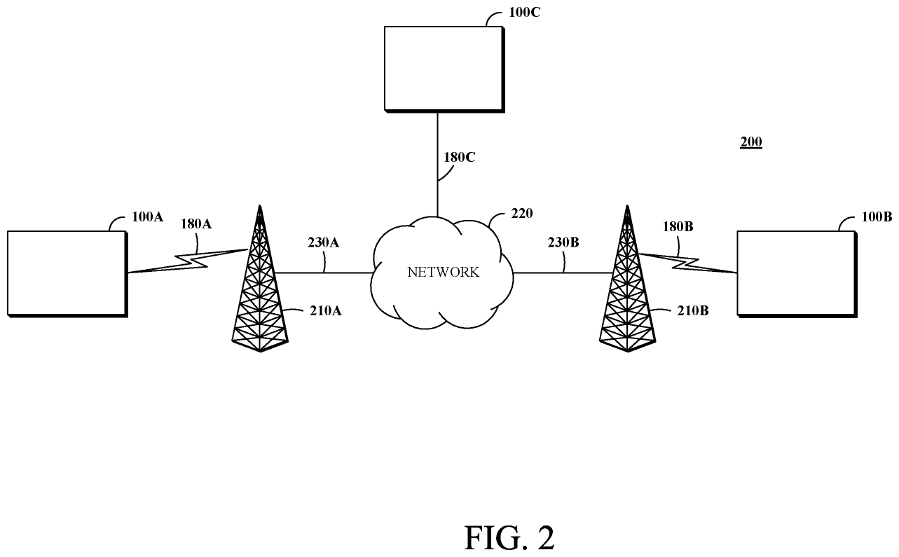

FIG. 2 is a diagram of a computing and communications system 200 in accordance with implementations of this disclosure. The computing and communications system 200 may include one or more computing and communication devices 100A, 100B, 100C, one or more access points 210A, 210B, one or more networks 220, or a combination thereof. For example, the computing and communication system 200 can be a multiple access system that provides communication, such as voice, data, video, messaging, broadcast, or a combination thereof, to one or more wired or wireless communicating devices, such as the computing and communication devices 100A, 100B, 100C. Although, for simplicity, FIG. 2 shows three computing and communication devices 100A, 100B, 100C, two access points 210A/210B, and one network 220, any number of computing and communication devices, access points, and networks can be used.

A computing and communication device 100A, 100B, 100C can be, for example, a computing device, such as the computing device 100 shown in FIG. 1. For example, as shown the computing and communication devices 100A, 100B may be user devices, such as a mobile computing device, a laptop, a thin client, or a smartphone, and computing and the communication device 100C may be a server, such as a mainframe or a cluster. Although the computing and communication devices 100A, 100B are described as user devices, and the computing and communication device 100C is described as a server, any computing and communication device may perform some or all of the functions of a server, some or all of the functions of a user device, or some or all of the functions of a server and a user device.

Each computing and communication device 100A, 100B, 100C can be configured to perform wired or wireless communication. For example, a computing and communication device 100A, 100B, 100C can be configured to transmit or receive wired or wireless communication signals and can include a user equipment (UE), a mobile station, a fixed or mobile subscriber unit, a cellular telephone, a personal computer, a tablet computer, a server, consumer electronics, or any similar device. Although each computing and communication device 100A, 100B, 100C is shown as a single unit, a computing and communication device can include any number of interconnected elements.

Each access point 210A, 210B can be any type of device configured to communicate with a computing and communication device 100A, 100B, 100C, a network 220, or both via wired or wireless communication links 180A, 180B, 180C. For example, an access point 210A, 210B can include a base station, a base transceiver station (BTS), a Node-B, an enhanced Node-B (eNode-B), a Home Node-B (HNode-B), a wireless router, a wired router, a hub, a relay, a switch, or any similar wired or wireless device. Although each access point 210A, 210B is shown as a single unit, an access point can include any number of interconnected elements.

The network 220 can be any type of network configured to provide services, such as voice, data, applications, voice over internet protocol (VOIP), or any other communications protocol or combination of communications protocols, over a wired or wireless communication link. For example, the network 220 can be a local area network (LAN), wide area network (WAN), virtual private network (VPN), a mobile or cellular telephone network, the Internet, or any other means of electronic communication. The network can use a communication protocol, such as the transmission control protocol (TCP), the user datagram protocol (UDP), the internet protocol (IP), the real-time transport protocol (RTP), the Hyper Text Transport Protocol (HTTP), or any combination thereof.

The computing and communication devices 100A, 100B, 100C can communicate with each other via the network 220 using one or more a wired or wireless communication links, or via a combination of wired and wireless communication links. For example, as shown the computing and communication devices 100A, 100B can communicate via wireless communication links 180A, 180B, and computing and communication device 100C can communicate via a wired communication link 180C. Any of the computing and communication devices 100A, 100B, 100C may communicate using any wired or wireless communication link, or links. For example, a first computing and communication device 100A can communicate via a first access point 210A using a first type of communication link, a second computing and communication device 100B can communicate via a second access point 210B using a second type of communication link, and a third computing and communication device 100C can communicate via a third access point (not shown) using a third type of communication link. Similarly, the access points 210A, 210B can communicate with the network 220 via one or more types of wired or wireless communication links 230A, 230B. Although FIG. 2 shows the computing and communication devices 100A/100B/100C in communication via the network 220, the computing and communication devices 100A, 100B, 100C can communicate with each other via any number of communication links, such as a direct wired or wireless communication link.

Other implementations of the computing and communications system 200 are possible. For example, the network 220 can be an ad-hock network and can omit one or more of the access points 210A, 210B. The computing and communications system 200 may include devices, units, or elements not shown in FIG. 2. For example, the computing and communications system 200 may include many more communicating devices, networks, and access points.

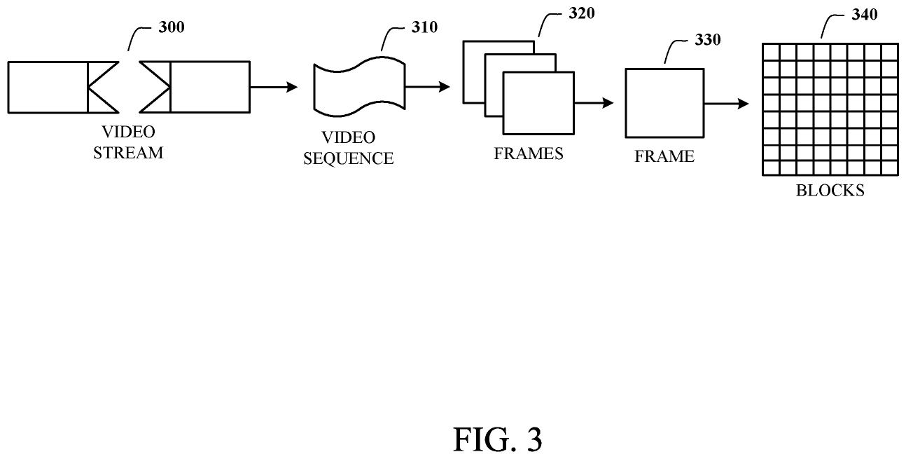

FIG. 3 is a diagram of a video stream 300 for use in encoding and decoding in accordance with implementations of this disclosure. A video stream 300, such as a video stream captured by a video camera or a video stream generated by a computing device, may include a video sequence 310. The video sequence 310 may include a sequence of adjacent frames 320. Although three adjacent frames 320 are shown, the video sequence 310 can include any number of adjacent frames 320. Each frame 330 from the adjacent frames 320 may represent a single image from the video stream. A frame 330 may include blocks 340. Although not shown in FIG. 3, a block can include pixels. For example, a block can include a 16×16 group of pixels, an 8×8 group of pixels, an 8×16 group of pixels, or any other group of pixels. Unless otherwise indicated herein, the term ‘block’ can include a superblock, a macroblock, a segment, a slice, or any other portion of a frame. A frame, a block, a pixel, or a combination thereof can include display information, such as luminance information, chrominance information, or any other information that can be used to store, modify, communicate, or display the video stream or a portion thereof.

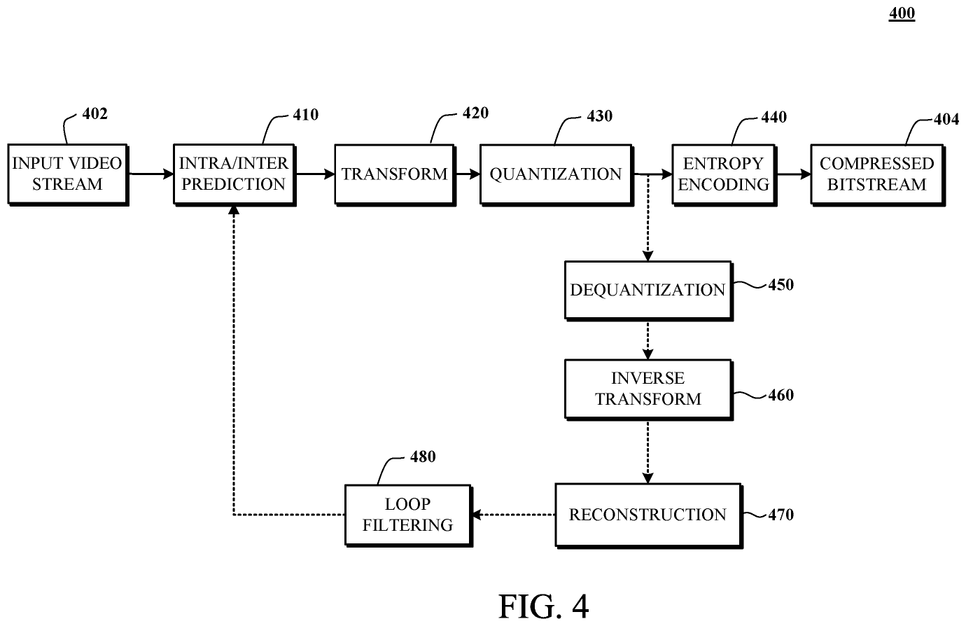

FIG. 4 is a block diagram of an encoder 400 in accordance with implementations of this disclosure. Encoder 400 can be implemented in a device, such as the computing device 100 shown in FIG. 1 or the computing and communication devices 100A/100B/100C shown in FIG. 2, as, for example, a computer software program stored in a data storage unit, such as the memory 150 shown in FIG. 1. The computer software program can include machine instructions that may be executed by a processor, such as the processor 140 shown in FIG. 1, and may cause the device to encode video data as described herein. The encoder 400 can be implemented as specialized hardware included, for example, in computing device 100.

The encoder 400 can encode an input video stream (i.e., the video stream 402), which may be the video stream 300 shown in FIG. 3, to generate an encoded (compressed) bitstream 404. In some implementations, the encoder 400 may include a forward path for generating the compressed bitstream 404. The forward path may include an intra/inter-prediction unit 410, a transform unit 420, a quantization unit 430, an entropy encoding unit 440, or any combination thereof. In some implementations, the encoder 400 may include a reconstruction path (indicated by the broken connection lines) to reconstruct a frame for encoding of further blocks. The reconstruction path may include a dequantization unit 450, an inverse transform unit 460, a reconstruction unit 470, a loop filtering unit 480, or any combination thereof. Other structural variations of the encoder 400 can be used to encode the video stream 402.

For encoding the video stream 402, each frame within the video stream 402 can be processed in units of blocks. Thus, a current block may be identified from the blocks in a frame, and the current block may be encoded.

At the intra/inter-prediction unit 410, the current block can be encoded using either intra-frame prediction, which may be within a single frame, or inter-frame prediction, which may be from frame to frame. Intra-prediction may include generating a prediction block from samples in the current frame that have been previously encoded and reconstructed. Inter-prediction may include generating a prediction block from samples in one or more previously constructed reference frames. Generating a prediction block for a current block in a current frame may include performing motion estimation to generate a motion vector indicating an appropriate reference block in the reference frame.

The intra/inter-prediction unit 410 may subtract the prediction block from the current block (raw block) to produce a residual block. The transform unit 420 may perform a block-based transform, which may include transforming the residual block into transform coefficients in, for example, the frequency domain. Examples of block-based transforms include the Karhunen-Loeve Transform (KLT), the Discrete Cosine Transform (DCT), and the Singular Value Decomposition Transform (SVD). In an example, the DCT may include transforming a block into the frequency domain. The DCT may include using transform coefficient values based on spatial frequency, with the lowest frequency (DC) coefficient at the top-left of the matrix and the highest frequency coefficient at the bottom-right of the matrix.

The quantization unit 430 may convert the transform coefficients into discrete quantum values, which may be referred to as quantized transform coefficients or quantization levels. The quantized transform coefficients can be entropy encoded by the entropy encoding unit 440 to produce entropy-encoded coefficients. Entropy encoding can include using a probability distribution metric. The entropy-encoded coefficients and information used to decode the block, which may include the type of prediction used, motion vectors, and quantizer values, can be output to the compressed bitstream 404. The compressed bitstream 404 can be formatted using various techniques, such as run-length encoding (RLE) and zero-run coding.

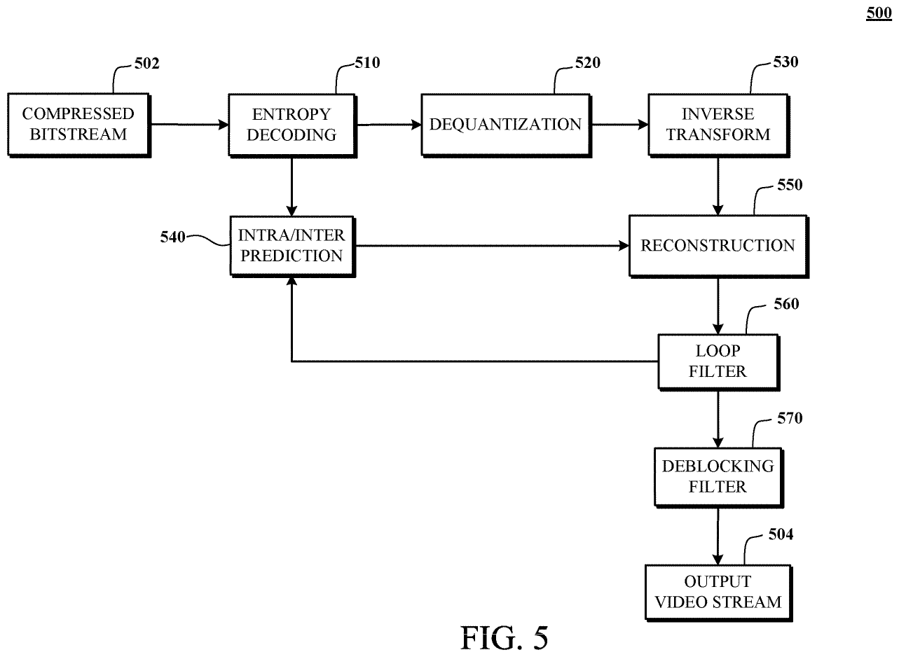

The reconstruction path can be used to maintain reference frame synchronization between the encoder 400 and a corresponding decoder, such as the decoder 500 shown in FIG. 5. The reconstruction path may be similar to the decoding process discussed below and may include dequantizing the quantized transform coefficients at the dequantization unit 450 and inverse transforming the dequantized transform coefficients at the inverse transform unit 460 to produce a derivative residual block. The reconstruction unit 470 may add the prediction block generated by the intra/inter-prediction unit 410 to the derivative residual block to create a reconstructed block. The loop filtering unit 480 can be applied to the reconstructed block to reduce distortion, such as blocking artifacts.

Other variations of the encoder 400 can be used to encode the compressed bitstream 404. For example, a non-transform-based encoder 400 can quantize the residual block directly without the transform unit 420. In some implementations, the quantization unit 430 and the dequantization unit 450 may be combined into a single unit.

FIG. 5 is a block diagram of a decoder 500 in accordance with implementations of this disclosure. The decoder 500 can be implemented in a device, such as the computing device 100 shown in FIG. 1 or the computing and communication devices 100A/100B/100C shown in FIG. 2, as, for example, a computer software program stored in a data storage unit, such as the memory 150 shown in FIG. 1. The computer software program can include machine instructions that may be executed by a processor, such as the processor 140 shown in FIG. 1, and may cause the device to decode video data as described herein. The decoder 500 can be implemented as specialized hardware included, for example, in computing device 100.

The decoder 500 may receive a compressed bitstream 502, such as the compressed bitstream 404 shown in FIG. 4, and may decode the compressed bitstream 502 to generate an output video stream 504. The decoder 500 may include an entropy decoding unit 510, a dequantization unit 520, an inverse transform unit 530, an intra/inter prediction unit 540, a reconstruction unit 550, a loop filtering unit 560, a deblocking filtering unit 570, or any combination thereof. Other structural variations of the decoder 500 can be used to decode the compressed bitstream 502.

The entropy decoding unit 510 may decode data elements within the compressed bitstream 502 using, for example, Context Adaptive Binary Arithmetic Decoding, to produce a set of quantized transform coefficients. The dequantization unit 520 can dequantize the quantized transform coefficients, and the inverse transform unit 530 can inverse transform the dequantized transform coefficients to produce a derivative residual block, which may correspond with the derivative residual block generated by the inverse transform unit 460 shown in FIG. 4. Using header information decoded from the compressed bitstream 502, the intra/inter prediction unit 540 may generate a prediction block corresponding to the prediction block created in the encoder 400. At the reconstruction unit 550, the prediction block can be added to the derivative residual block to create a reconstructed block. The loop filtering unit 560 can be applied to the reconstructed block to reduce blocking artifacts. The deblocking filtering unit 570 can be applied to the reconstructed block to reduce blocking distortion, and the result may be output as the output video stream 504.

Other variations of the decoder 500 can be used to decode the compressed bitstream 502. For example, the decoder 500 can produce the output video stream 504 without the deblocking filtering unit 570.

In some implementations, reducing temporal redundancy may include using similarities between frames to encode a frame using a relatively small amount of data based on one or more reference frames, which may be previously encoded, decoded, and reconstructed frames of the video stream. For example, a block or pixel of a current frame may be similar to a spatially corresponding block or pixel of a reference frame. In some implementations, a block or pixel of a current frame may be similar to block or pixel of a reference frame at a different portion, and reducing temporal redundancy may include generating motion information indicating the spatial difference, or translation, between the location of the block or pixel in the current frame and corresponding location of the block or pixel in the reference frame.

In some implementations, reducing temporal redundancy may include identifying a block or pixel in a reference frame, or a portion of the reference frame, that corresponds with a current block or pixel of a current frame. For example, a reference frame, or a portion of a reference frame, which may be stored in memory, may be searched for the best block or pixel to use for encoding a current block or pixel of the current frame. For example, the search may identify the block of the reference frame for which the difference in pixel values between the reference block and the current block is minimized, and may be referred to as motion searching. In some implementations, the portion of the reference frame searched may be limited. For example, the portion of the reference frame searched, which may be referred to as the search area, may include a limited number of rows of the reference frame. In an example, identifying the reference block may include calculating a cost function, such as a sum of absolute differences (SAD), between the pixels of the blocks in the search area and the pixels of the current block. In some implementations, more than one reference frame may be provided. For example, three reference frames may be selected from eight candidate reference frames.

In some implementations, the spatial difference between the location of the reference block in the reference frame and the current block in the current frame may be represented as a motion vector. The difference in pixel values between the reference block and the current block may be referred to as differential data, residual data, or as a residual block. In some implementations, generating motion vectors may be referred to as motion estimation, a pixel of a current block may be indicated based on location using Cartesian coordinates as f_{x,y}. Similarly, a pixel of the search area of the reference frame may be indicated based on location using Cartesian coordinates as r_{x,y}. A motion vector (MV) for the current block may be determined based on, for example, a SAD between the pixels of the current frame and the corresponding pixels of the reference frame.

In some implementations, for inter-prediction, the encoder 400 may convey encoded information for prediction blocks at block end points, including but not limited to a prediction mode, the prediction reference frame(s), motion vector(s) if needed, subpixel interpolation filter type.

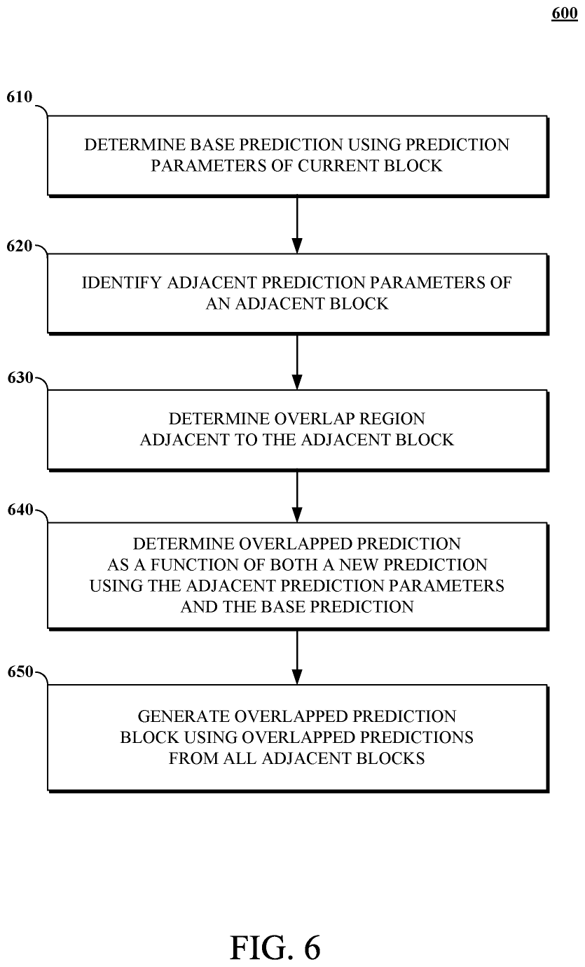

FIG. 6 is a flowchart diagram of an example of a technique 600 for adaptive overlapped block prediction in accordance with implementations of this disclosure. Adaptive overlapped block prediction may be implemented in an encoder, such as a prediction performed by intra/inter-prediction unit 410 of the encoder 400 as shown in FIG. 4, or in a decoder, such as a prediction based on compressed bitstream 502 performed by intra/inter prediction unit 540 in decoder 500 shown in FIG. 5. In some implementations, adaptive overlapped block prediction may include determining a base prediction of the current block based on prediction parameters for the current block at 610, identifying adjacent prediction parameters of an adjacent block at 620, determining an overlap region adjacent to the adjacent block in the current block at 630, determining an overlapped prediction of the overlap region as a weighted function of the base prediction, and a prediction based on the adjacent prediction parameters at 640, generating an overlapped prediction block based on combining the overlapped predictions at 650, or a combination thereof.

A base prediction for the current block may be performed at 610 using current prediction parameters for the current block. For example, the prediction parameters for inter-prediction may include a reference frame and motion vectors of the current block. A base prediction block may be determined using the base prediction of the current block.

Adjacent prediction parameters may be identified at 620. In some implementations, identifying the adjacent prediction parameters may include identifying previously encoded or decoded adjacent blocks, and for each of the previously encoded or decoded adjacent blocks, identifying the prediction parameters used for encoding or decoding the adjacent block.

An overlap region may be determined at 630. In some implementations, an overlap region in the current block may be determined for one or more of the encoded or decoded adjacent blocks identified at 620. The overlap region may include a region, such as a grouping of pixels, within the current block that is adjacent to the corresponding adjacent block. The overlap region determination may be conditional on whether there is at least one previously encoded or decoded adjacent block smaller in size than the current block.

An overlapped prediction may be determined at 640. In some implementations, an overlapped prediction for the overlap region identified at 630 may be determined based on a weighted function of the base prediction determined at 610 and a prediction generated using the adjacent prediction parameters from the corresponding adjacent block to predict pixel values in the current block within the overlap region. For example, for an overlap region, a prediction block of a size equivalent to the size of the overlap region may be determined using the prediction parameters of the corresponding adjacent block. The overlapped prediction may be performed for the overlap region based on a weighted combination of a base prediction block pixel values and the prediction block pixel values generated for the overlap region based on the prediction parameters of the corresponding adjacent block. For example, the pixel value for a pixel in the overlap region may be a weighted average of the pixel value from the base prediction block and the corresponding pixel value from the prediction block generated for the overlap region based on the prediction parameters of the corresponding adjacent block. In some implementations, generating prediction blocks for the respective overlap regions may be omitted, and the overlapped prediction block may be generated on a pixel-by-pixel basis.

An overlapped prediction block may be generated using overlapped predictions from one or more adjacent blocks at 650. For example, the overlapped prediction at 640 may be repeated for one or more overlap region within the current block to form the overlapped prediction block.

In some implementations, a portion of the current block that does not correspond spatially with the overlap regions for the current block may be predicted based on the base prediction.

In some implementations, an overlapped prediction block for the current block may be compared to the base prediction block, and the base prediction or the overlapped prediction block may be used as the prediction block for the current block. For example, the comparison may be based on residual-based error metric, and the encoder 400 may select the prediction block producing lower error values.

In some implementations, information that indicates that an overlapped prediction was performed on the current block may be included in the encoded bitstream. For example, an indication of a type of weighted function used for the overlapped prediction may be indicated in the encoded bitstream. In some implementations, an indication of the weighted function may be omitted from the encoded bitstream, and decoding the encoded bitstream may include determining a weighted function using context information of previously decoded adjacent frames. For example, decoding may include identifying a weighted function based on which adjacent block prediction parameters produce the smallest residual-based errors.

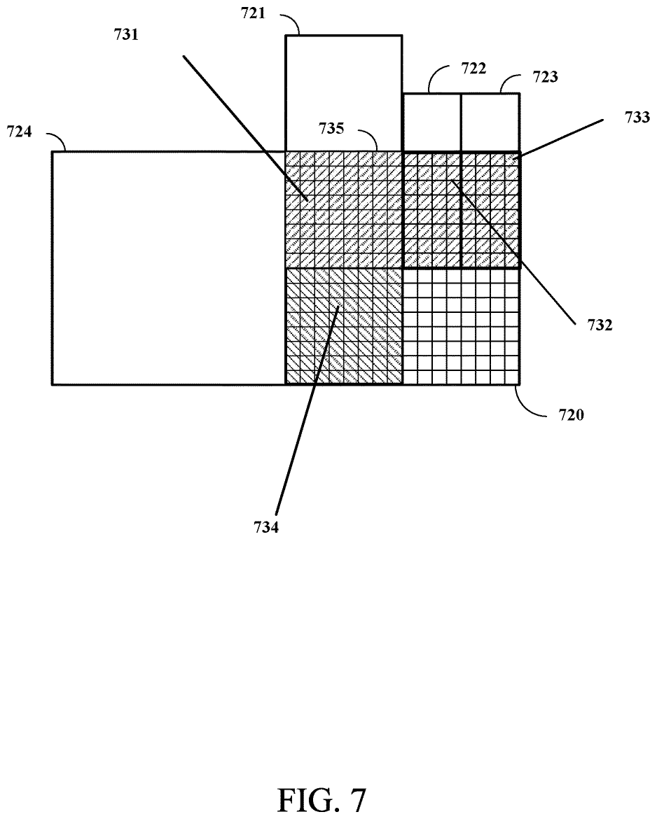

FIG. 7 is a block diagram of an example block based prediction with variable block sizes in accordance with implementations of this disclosure. In some implementations, at least one side of the current block may be adjacent to two or more previously encoded or decoded blocks. As shown, current block 720 for prediction is surrounded by previously encoded or decoded top adjacent blocks 721, 722, 723 and left adjacent block 724. Although the previously encoded or decoded adjacent blocks are shown in FIG. 7 to be above and to the left of current block 720, in some implementations, previously encoded or decoded adjacent blocks may be below or to the right of the current block, or some combination of top, left, bottom or right.

As shown in FIG. 7, current block 720 is a 16×16 block, adjacent block 721 is an 8×8 block, adjacent blocks 722, 723 are 4×4 blocks, and adjacent block 724 is a 16×16 block. Although 16×16, 8×8, and 4×4 blocks are shown in FIG. 7, any other block sizes may be used in accordance with this disclosure.

In some implementations, an overlap region may be determined for the overlapped prediction of current block 720 with respect to one or more previously encoded or decoded adjacent blocks. For example, pixels in current block 720 may be grouped within defined overlap regions, where an overlap region may be determined for one or more top adjacent block, such as overlap regions 731, 732, and 733 corresponding to adjacent blocks 721, 722, and 723, respectively, and overlap region 734, shown as at the left half of current block 720, corresponding to left adjacent block 724. As shown in FIG. 7, overlap regions may overlap, such as overlap regions 731 and 734, where overlap region 731 includes an intersection of overlap regions corresponding to top adjacent block 721 and left adjacent block 724. As shown, the overlap regions 731-734 are within the current block 720 and are adjacent to respective corresponding adjacent blocks 721-724.

In some implementations, the weighted function for the overlapped prediction may determine the overlap region size. The size of the overlap region may correspond with the size of the corresponding adjacent block, such as a corresponding column dimension v, row dimension w, or both. In some implementations, a v×w overlap region size may correspond to an x×y adjacent block size, where v=x and w=y. For example, an overlap region such as an 8×8 overlap region 731 within current block 720, as shown in FIG. 7, may be determined with respect to 8×8 adjacent block 721.

The size of the overlap region may correspond with the size of the current block, such as such as a corresponding column dimension v, row dimension w, or both. In some implementations, a v×w overlap region size may correspond to an x′×y′ current block size, where v=x′ and w=y′. As an example, the current block may be smaller than an adjacent block, and the overlap region size for one dimension may be limited to the size of the current block at the boundary of the adjacent block. As another example, 4×8 overlap regions 732 and 733 as shown in FIG. 7 may be determined with respect to 4×4 adjacent blocks 722 and 733, respectively, and the number of rows corresponding to half of a 16×16 current block size dimension, where w=½ y′=8. In some implementations, a v×w overlap region size may correspond to an x′×y′ current block size, where

$$v = \frac{{x}^{′}}{2}$$

and w=y′. For example, an 8×16 overlap region 734 may be determined with respect to 16×16 left adjacent block 724. In some implementations, the size of the overlap region may correspond with both the adjacent block size and the current block size. Other variants of overlap region sizes may be used.

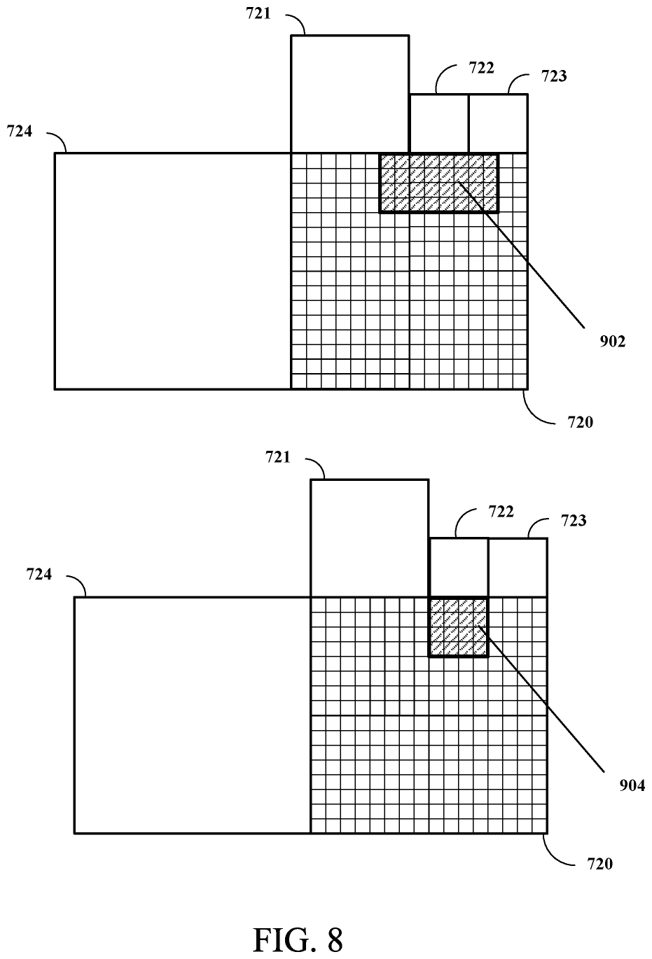

In some implementations, a weighted function index that indicates which one of various discrete overlap region sizes is used as a common size for all overlap regions may be included in the encoded bitstream, decoding the block may include decoding the index to determine which of the discrete overlap region sizes to use for the overlapped prediction weighted function. As an example, a first index may indicate that all overlap regions have a size with a first dimension equal to the adjacent block edge length, and a second dimension that extends ½ the length of current block, such as overlap region 732 shown in FIG. 7. A second index may indicate that all overlap regions have a first dimension equal to the adjacent block edge, and a second dimension that extends ¼ the length of the current block, such as overlap region 904 shown in FIG. 8. In some implementations, encoding may include determining a weighted function that maps different relative sizes for each of the overlap regions, depending on prediction parameters for the adjacent blocks. For example, encoding may include generating multiple prediction block candidates according to various weighted functions, determining a rate distortion cost estimate for each candidate, and selecting the weighted function that provides the best rate distortion optimization.

FIG. 8 is a block diagram of example size variations of overlap regions in accordance with implementations of this disclosure. In some implementations, a dimension of the overlap region may exceed a corresponding dimension of the corresponding adjacent block. For example, as shown in FIG. 8, overlap region 902 corresponding with adjacent block 722 may be determined to have a horizontal size greater than the number of horizontal pixels in corresponding adjacent block 722, and equal in vertical size. As another example, overlap region 904 corresponding with adjacent block 722 may be determined according to the horizontal size of the adjacent block, and ¼ the vertical size of the current block. In some implementations, both horizontal and vertical dimensions of the overlap region may exceed corresponding dimensions of the corresponding adjacent block. In some implementations, both horizontal and vertical dimensions of the overlap region may be exceeded by corresponding dimensions of the corresponding adjacent block.

Various overlap region sizes may be determined by using a set of discrete sizing functions, from which the overlap region size may be adaptively selected as a function of a difference between prediction parameters of the current block and the adjacent prediction parameters of the corresponding adjacent block. In some implementations, a comparison between motion vectors of the current block and motion vectors of the corresponding adjacent block for the overlap region may indicate a motion vector difference that exceeds a threshold, and one or more dimensions of a default overlap region size may be adjusted. In some implementations, the determination of the difference of the prediction parameters between the adjacent block and the current block may be based on a comparison of the temporal distance between reference frames for the adjacent block and for the current block respectively. For example, the reference frame for the adjacent block may be the previously encoded frame and the reference frame for the current block may be a frame encoded prior to the previously encoded frame, and the difference may be measured by number of frames, or temporal distance, between the reference frames.

In some implementations, both the adjacent block and the current block may be predicted according to an inter-prediction, in which case overlap region sizing of the weighted function may be according to the above description. In some implementations, one of the adjacent blocks or the current block may be predicted according to an intra-prediction with the other being predicted according to an inter-prediction, thus a usable comparison of prediction parameters may not be available. When a comparison of prediction parameters is not available, the weighted function may define an overlap region size according to a predetermined function of current block size. For example, the overlap region size may be defined as a small overlap region, such as being based on ¼ of current block length. As another example, the size for the overlap region may be set to zero, or no overlap region, since the adjacent prediction may be considered too different from the current block prediction, and overlapped prediction can be omitted.

In some implementations, a defined overlap region size may range between (0,0), which may indicate no overlap region, and a x′×y′, which may indicate the current block size. The weighted function for the overlapped prediction may adjust the defined overlap region size based on a difference between prediction parameters. For example, for an overlap region, such as the overlap region 732 shown in FIG. 7, motion vector values of adjacent block 722 may be very similar to motion vector values of the current block, such as current block 720 shown in FIG. 7, and the size adjustment to the defined overlap size may be omitted. As another example, the motion vector values of an adjacent block, such as adjacent block 722 shown in FIG. 7, may differ from motion vector values of a current block, such as the current block 720 shown in FIG. 7, the difference may exceed an established threshold, and the overlap region size may be adjusted. For example, the overlap region may be expanded, as shown for overlap region 902, or may be contracted as shown for overlap region 904, as shown in FIG. 8. In some implementations, adapting the overlap region size based on differences between prediction parameters, may include adapting the weighted function of the overlapped prediction such that the weighting can be weighted to favor the contribution of the current block prediction parameters or the adjacent block prediction parameters depending on which prediction parameters optimize the overlapped prediction of the current block. For example, the weighted function may weight a contribution from the adjacent block prediction parameters to zero for some pixels in the current block by setting at least one dimension of the overlap region to be less than a corresponding dimension of the current block.

In some implementations, an overlap region may be omitted on a condition that the difference between prediction parameters of the current block and the adjacent block exceeds a threshold (i.e., the size of the overlap region is 0×0). In some implementations, an overlap region may be omitted on a condition that there is little or no difference between prediction parameters of the current block and the adjacent block. For example, the current block prediction may be substantially similar to the adjacent block prediction, the difference between prediction parameters may be less than a minimum threshold, and the size of the overlap region may be 0×0.

In some implementations, a base prediction may be determined for current block 720 using prediction parameters for current block 720. The base prediction may then be the base prediction for each of the overlap regions 731 to 734. For example, a base prediction block may be determined for the entire current block, such that pixel values for the base prediction may be stored for later use when determining the overlapped prediction for each pixel in the overlap regions of the current block 720.

In some implementations, a prediction may be determined for each of the overlap regions, such as the overlap regions 731-734 shown in FIG. 7, based on prediction parameters of the adjacent block associated with the overlap region. For example, a prediction may be determined for the pixels in an overlap region, such as the overlap region 732 shown in FIG. 7, using prediction parameters that include corresponding reference frame and motion vectors for an adjacent block, such as adjacent block 722 shown in FIG. 7.

In some implementations, an overlapped prediction may be determined for one or more overlap region, such as the overlap regions 731-734 shown in FIG. 7, as a weighted function of the base prediction and predictions based on the respective adjacent prediction parameters. For example, the overlapped prediction for each pixel in overlap region, such as overlap region 732 shown in FIG. 7, may be an average of the base prediction value and the prediction pixel value generated based on the respective adjacent prediction parameters. In some implementations, there may be more than one overlap region for a pixel in the current block. For example, two or more adjacent overlap regions may overlap, such as overlap regions 731, 732, and 733 shown in FIG. 7 and the overlapped prediction may be determined as an average of the base prediction based on the prediction parameters for the current block, and n predictions based on the respective prediction parameters for each of the n adjacent blocks associated with the overlap regions. For example, referring to FIG. 7, pixels in both overlap regions 731 and 734 correspond to two predictions based on the respective adjacent prediction parameters (i.e., n=2) which may be averaged with the base prediction to determine the overlapped prediction. In some implementations, each pixel in the overlap region 731 may be determined as an average of a base prediction using prediction parameters of the current block 720, a prediction based on prediction parameters of the adjacent block 721, and a prediction based on prediction parameters of the adjacent block 724.

In some implementations, the weighted function for overlapped prediction may be a function of distance between the center of the current block and the center of an adjacent block associated with the overlap region. For example, the weighted function may determine an overlapped prediction that favors smaller sized adjacent blocks, which may include pixels located, on average, closer to the current block than larger adjacent blocks, may be more reliable, and to provide a better prediction of the current block. For example, the weighted function may weight overlap region 732 to contribute more heavily to the overlapped prediction of current block 720 than larger overlap region 734, as the center of adjacent block 722 is closer to the center of current block 720 compared to the center of adjacent block 724.

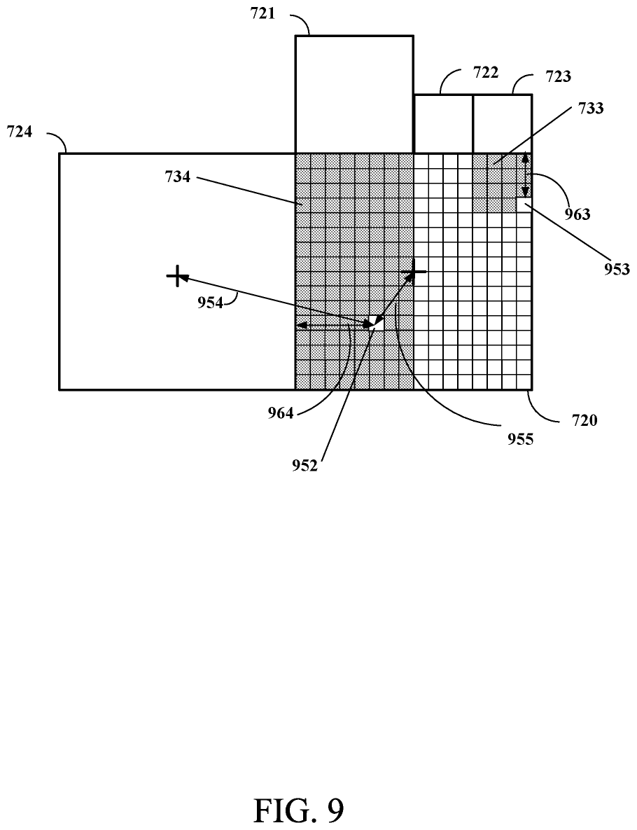

FIG. 9 is a block diagram of an example weighted function for overlapped prediction in accordance with implementations of this disclosure. The overlapped prediction may be optimized by a weighted average of the first prediction and the n adjacent block-based predictions. For example, P₀ may indicate the prediction using current block prediction parameters, ω₀ may indicate the weight for prediction P₀, Pₙ may indicate the prediction using adjacent block prediction parameters, on may indicate the weight for prediction Pₙ, and weighting of the overlapped prediction OP of pixel 952 may be expressed as the following:

$$O P = \frac{1}{N + 1} ( {ω}_{0} {P}_{0} + {\sum }_{n = 1}^{N} {ω}_{n} {P}_{n} ) \qquad ( 1 )$$

In some implementations, one or more predicted pixel value at each pixel in an overlap region may be weighted according to a weighted function based on the relative pixel position with respect to the adjacent block associated with the overlap region. For example, the overlapped prediction may be weighted such that a contribution by the prediction based on adjacent block prediction parameters is greater when the pixel is located relatively nearer to the adjacent block. For example, pixel 952 in overlap region 734 shown in FIG. 9 has a relative distance 954 to the center of corresponding adjacent block 724 and a relative distance 955 to the center of current block 720. In some implementations, overlapped prediction weights ω₀, ωₙ may be a function of relative distances 954, 955. For example, d₀ may indicate the relative distance from pixel to center of current block, dₙ may indicate the relative distance from pixel to center of adjacent block n, and the weighted function may be a proportion of relative distance values, which may be expressed as follows:

$${ω}_{0} = \frac{{d}_{0}}{{d}_{0} + {d}_{n}} \qquad ( 2 )$$

$${ω}_{n} = \frac{{d}_{n}}{{d}_{0} + {d}_{n}} \qquad ( 3 )$$

In some implementations, overlapped prediction weights w₀, wₙ may be a function of a directional relative distance between the pixel and the boundary between the adjacent block and the current block, such as horizontal relative distance 964 for left adjacent block 724. For example, the weighted function may be based on a raised cosine window function in which weights ω₀, ωₙ are equal for a pixel located at the adjacent edge of overlap region n, and weights are ω₀=1, ωₙ=0 for a pixel located at the edge of the overlap region farthest from adjacent block n. As another example, overlapped prediction weights ω₀, ωₙ may be a function of a vertical relative distance between the pixel and the nearest edge of the adjacent block, such as vertical relative distance 963 for pixel 953 with respect to top adjacent block 723.

In some implementations, the type of weighted function used for the overlapped prediction be encoded with an index, such as by encoder 400 shown in FIG. 4, and included in the compressed video bitstream, such as the compressed bitstream 404 shown in FIG. 4, as an indication for decoding, such as by the decoder 500 shown in FIG. 5, of which weighted function to use for overlapped prediction. For example, various raised cosine weightings may be mapped to a first set of indexes, and various weighted functions based on relative distance to block center points may be mapped to a second set of indexes.

The weighted function for overlapped prediction may be a combination of any or all weighted functions described in this disclosure. For example, the weighted function may be implemented to weight the overlapped prediction by adaptive adjustment of overlap region size, by weighting each of the base prediction and overlapped predictions for the current block, or a combination thereof.

Described above are implementations of overlapped prediction that only use motion information of neighboring (peripheral and adjacent) blocks of a current block where the neighboring blocks are to above or to the left of a current block. However, other implementations are possible. In some situations, overlapped prediction may be applied to sub-blocks of a block, which may be a largest coding unit (which may be referred to as a macroblock or a superblock), or a block that is smaller than a largest coding unit. In an example, a coding mode may indicate that the block is to be predicted at a certain sub-block level. As such, for example, a block of size N×N (e.g., 16×16) may be partitioned into b² (e.g., b=4) M×M (e.g., 4×4) blocks, where N=b*M. Overlapped prediction may be performed for at least some of the b² blocks. For ease of reference, overlapped prediction at the sub-block level is also be referred to herein as sub-block overlapped prediction.

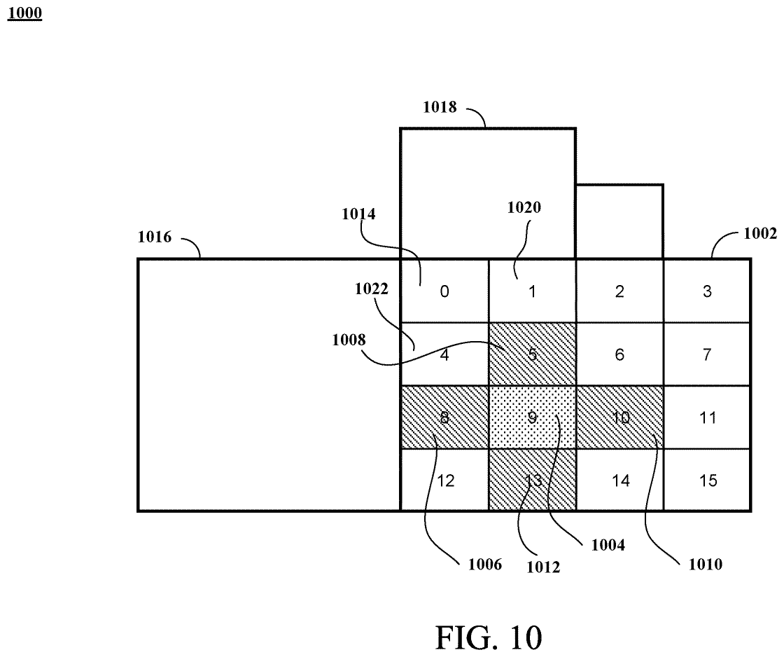

FIG. 10 is a block diagram 1000 illustrating sub-block overlapped prediction. Sub-block overlapped prediction can be used to smooth (e.g., correct) boundaries of sub-blocks of a block, therewith reducing blockiness artefacts of the sub-blocks. Similar to the overlapped prediction described above, in sub-block overlapped prediction, a prediction obtained using motion information (e.g., a motion vector and reference frame) of a current sub-block is combined (e.g., weighed) with predictions obtained using respective motion information of one or more neighboring blocks. However, in sub-block overlapped prediction, the neighboring blocks can be peripheral neighboring blocks, sub-blocks of the same block as the current sub-block, blocks that follow the current sub-block in raster scan order, or a combination thereof.

The block diagram 1000 includes a block 1002 that is partitioned into sub-blocks. The sub-blocks of the block 1002 are numbered from 0 to 15. While FIG. 10 shows that the block 1002 is partitioned into 16 sub-blocks, the disclosure is not so limited. The block 1002 can be partitioned into more or fewer sub-blocks. The number of sub-blocks may depend on the size of the block 1002.

In sub-block overlapped prediction, motion information of at least some of the available blocks to the left, above, right, and bottom of a current sub-block may be used. To illustrate, when obtaining a prediction for the sub-block 1004, a current prediction P₀ of the sub-block 1004 (block numbered 9) is obtained using motion information (e.g., a motion vector(s) and reference frame(s)) determined for the sub-block 1004, a P_{L} prediction block is obtained using motion information of a left sub-block 1006, a P_{T} prediction block is obtained using motion information of an above sub-block 1008, a P_{R} prediction block is obtained using motion information of a right sub-block 1010, and a P_{B} prediction block is obtained using motion information of a bottom sub-block 1012.

A final prediction block may be obtained using a weighted sum of P₀, P_{L}, P_{T}, P_{R}, and P_{B}. In an example, the predictions may be combined in a certain order. In an example, the order can be circular starting with the left neighboring block. For example, P₁ may be obtained as (P₀+P_{L})/2, then P₂ may be obtained as (P₁+P_{T})/2, then P₃ may be obtained as (P₂+P_{R})/2, and then a final prediction is obtained as (P₃+P_{B})/2. In this way, only bit shift operations need be performed. As another illustration, a prediction of a sub-block 1014 can be obtained using motion information of a block 1016, a block 1018, a sub-block 1020, and a sub-block 1022.

Statements herein such as “overlapped prediction is applied (or performed) with the neighboring block for the current block” or “overlapped prediction is obtained based on the neighboring block” should be understood to mean that a prediction for the current block is to be obtained using motion information of neighboring block and that the obtained is to be included in a calculation of a final prediction block for the current block.

In some situations, overlapped prediction may not be applied to or may not be used for a current block (e.g., a sub-block) if one or more conditions apply. Examples of such conditions are now provided.

In an example, overlapped prediction may be disabled for all frames of a video sequence. For example, a syntax element in a sequence parameter set (SPS) may indicate that overlapped prediction is not to be applied for any blocks of any frames of the video sequence. As is known, an SPS can contain parameters common to an entire video sequence (i.e., to each of the frames of the video sequence). In an example, overlapped prediction may be disabled for a group frames. For example, a syntax element in a picture parameter set (PPS) may indicate that overlapped prediction is not to be applied for the group of frames corresponding to the PPS. As is known, a PPS can contain parameters common to all frames of the group of frames. In an example, overlapped prediction may not be performed for a current block that is intra-predicted.

In an example, overlapped prediction may not be applied to (e.g., performed for) a block if the size of the block is smaller than or equal to a threshold size. For example, overlapped prediction may not be performed for blocks that are smaller than or equal to 32×32 pixels. In an example, a block header of a current block may include one or more syntax elements indicating whether overlapped prediction is to be performed for the block. For example, the syntax element may be a prediction mode that indicates that overlapped prediction is to be performed for the block. In an example, the one or more syntax elements may be a flag indicating whether overlapped prediction is to be performed. Thus, overlapped prediction is not performed for a current block if the one or more syntax elements indicate that overlapped prediction is not to be performed for the current block.

In some examples, the flag indicating whether overlapped prediction is to be performed may be included in the header of the current block if the current block is not coded using a SKIP model or a MERGE mode. That is, if the current block is encoded using one of the SKIP or MERGE modes, then overlapped prediction is to be performed for the current block. The SKIP and MERGE modes are now briefly described. If a block is encoded using the SKIP mode, no residual information is transmitted from an encoder to a decoder for the current block. The decoder may estimate the motion for the current block encoded using the SKIP mode from a list of candidate motion vectors and may use (e.g., select) the motion vector to calculate a motion-compensated prediction for the current block. In the MERGE mode, a motion vector from a list of candidate motion vectors is inherited for coding the current block. The list of candidate motion vectors may also be referred to as a merge list where the merge list may refer to blocks whose motion vectors (or, more generally, motion information) are used to select a motion vector (or, more generally, motion information) for a current block.

In some situations, it may not be desirable to use overlapped prediction.

For example, overlapped prediction may not be efficient when a current block includes screen content, even if, for example, the current block is coded using one of the MERGE or SKIP modes. In such cases, overlapped prediction may result in the blurring of sharp edges in the screen content upon decoding. As mentioned above, a flag may be signaled for non-MERGE and non-SKIP predicted blocks. However, it may be useful to further indicate for such blocks whether overlapped prediction is or is not to be performed.

As another example, overlapped prediction may not be efficient when multiple reference frames are available for a current frame. When multiple reference frames are available, overlapped prediction may require the fetching of different samples (pixel values) from different reference pictures, which can significantly increase the memory bandwidth requirements. To illustrate, the sub-block 1014 may be predicted (e.g., bi-predicted) using reference frames R1 and R3, the block 1016 may be bi-predicted using reference frames R1 and R2, the sub-block 1020 may be bi-predicted using reference frames R1 and R3, the sub-block 1020 may be bi-predicted using reference frames R3 and R4, and the sub-block 1022 may be uni-predicted using reference frame R3. As such, performing overlapped prediction for the sub-block 1014 would require the fetching of samples from four different reference frames; namely, reference frames R1, R2, R3, and R4. This processing might have to be performed for each of the blocks.

Additionally, performing overlapped prediction for blocks of a P slice or frame greatly increases the coding complexity of P slice or frame. The coding of blocks of P slices or frames is desirably with the least amount of complexity possible, especially in real-time use cases of video coding.

The following techniques can be used to solve (or at least mitigate) issues such as the foregoing with respect to overlapped prediction.

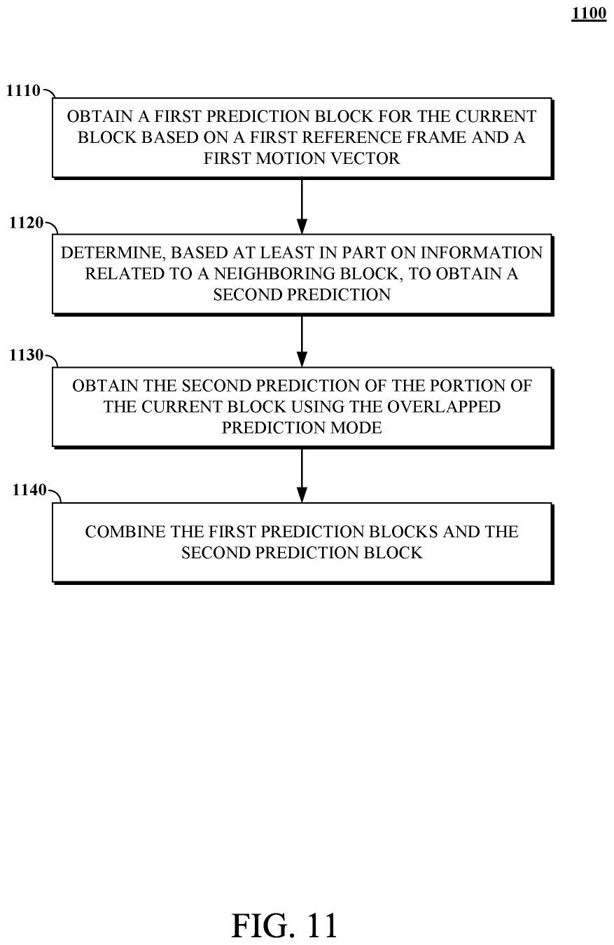

FIG. 11 is a flowchart diagram of a technique 1100 for coding a current block of a video frame using overlapped prediction. The technique 1100 can be implemented, for example, as a software program that may be executed by computing devices such as one or more of the computing and communication devices 100A/100B/100C for FIG. 2. The software program can include machine-readable instructions that may be stored in a memory, such as the memory 150 of FIG. 1, and that, when executed by a processor, such as the processor 140 of FIG. 1, may cause the computing device to perform the technique 1100. The technique 1100 may be implemented in whole or in part by the intra/inter prediction unit 540 of the decoder 500 of FIG. 5. The technique 1100 may be implemented in whole or in part by the intra/inter-prediction unit 410 of the encoder 400 of FIG. 4. The technique 1100 can be implemented using specialized hardware or firmware. Multiple processors, memories, or both, may be used.

The technique 1100 can conditionally apply overlapped prediction (e.g., sub-block overlapped prediction) to a current block (e.g., a current sub-block) based on information available at the decoder, such as motion information, or predicted sample values of blocks neighboring the current block and which may be available for performing overlapped prediction, such as described with respect to FIG. 10.

In an example, the technique 1100 can be applied to all blocks of the current frame that are predicted using inter-prediction. In an example, whether to apply overlapped prediction can be inferred at the decoder based on the information available at the decoder and no block-level syntax elements are required to indicate whether overlapped prediction is to be performed for a block. In another example, the conditions may be applied only when block-level overlapped prediction is signaled or derived as to be performed.

In an example, the technique 1100 may not be performed for P slices (i.e., for all block of P slices). Alternatively, to reduce complexity, overlapped prediction in P slices can be performed for a current block of a P slice using the motion information of a neighboring block when the current block and the neighboring block share the same reference frame(s) and the absolute motion vector differences between the motion vectors of the current block and the motion vectors of the neighboring block are below a predefined or signaled motion-vector threshold, which can be as described elsewhere herein.

In an example, overlapped prediction is applied for the current block only when the current block is coded using specific prediction modes. In an example, the specific prediction modes may include modes that are referred to as the affine mode and the subblock-based temporal motion vector prediction (SbTMVP) mode in the MPEG Versatile Video Coding (VVC); ITU-T H.266 video standard.

Briefly, the affine mode uses more degrees of freedom (parameters) than classical translation using motion vectors (which use 2 parameters). For example, an affine mode may use four parameters (to effectuate translation, rotation, and scaling) or six parameters (to effectuate translation, rotation, scaling, shearing, and an aspect ratio change). Briefly, the SbTMVP mode uses a motion field within a collocated frame of the current frame to improve motion vector prediction (MVP) and a merge mode of coding units within the current frame. In the SbTMVP mode, motion prediction may be performed at a subblock level or a sub coding unit (sub-CU) level. Additionally, SbTMVP applies a motion shift from the collocated frame and derives temporal motion information thereafter. The motion shift may include a process of obtaining a motion vector from one of spatial neighboring blocks of the current block and being shifted by the motion vector.

As already mentioned, applying overlapped prediction from a neighboring block of a current block may be defined as or includes obtaining a prediction based on motion information (e.g., one or more motion vectors) of a neighboring block and including that prediction in a weighted prediction that includes a prediction obtained for the current block using motion information associated with the current block.

At 1110, a first prediction block is obtained for the current block based on motion information associated with the first current block. The motion information may be or include a first reference frame and a first motion vector. More generally, the motion information may include more than one motion vector (and, relatedly, more than one reference frame). In an example, when the technique 1100 is implemented by a decoder, the motion information may be decoded from a compressed bitstream, such as the compressed bitstream 502 of FIG. 5.

At 1120, the technique 1100 determines to obtain a second prediction block of at least a portion of the current block using an overlapped prediction mode that uses a second reference frame and a second motion vector of a neighboring block. The second reference frame and a second motion vector are associated with a neighboring block of the current block. The motion information of the neighboring block may include more motion vectors than the second motion vector (and, relatedly, more reference frames than the second reference frame). The determination is based at least in part on information related to the neighboring block of the current block.

The second motion vector, as used herein, can be the actual motion vector of the neighboring block (i.e., the motion vector used to obtain a prediction of the neighboring block) or a motion vector that is obtained therefrom. As such, and for ease of reference, the “second motion vector,” in one example, refers to the actual motion vector of the neighboring block; and, in another example, the “second motion vector” refers to a motion vector obtained from the actual motion vector.

For example, the second prediction block may be obtained using a second motion vector that is obtained by rounding the actual motion vector to integer positions. By rounding the actual motion vector to integer positions, an interpolation process that would otherwise be performed to obtain subpixel values can be bypassed (e.g., avoided). The horizontal and the vertical components (MVₓ, MV_{y}) of the actual motion vector can both be rounded towards positive infinity, towards negative infinity, or towards zero. In another example, the horizontal and the vertical components can be independently rounded depending on their respective values. That is, if the component of the actual motion vector is positive, then the corresponding component of the second motion vector can be obtained by rounding towards positive infinity; and if the component of the actual motion vector is negative, then the corresponding component of the second motion vector can be obtained by rounding towards negative infinity.

In an example, the determination is made to obtain the second prediction block in response to determining that the current block and the neighboring block have (i.e., are predicted using) at least some of the same reference frame(s). As such, if the current block and the neighboring block are not predicted using at least some of the same reference frame, then overlapped prediction is not performed (applied) from the neighboring block. To illustrate, if the current block is bi-predicted using reference frames R1 and R2 and the neighboring block is also bi-predicted using reference frames R2 and R3, then a second prediction block is obtained at 1130 using only the reference frame R2 (and the motion vector used therewith for predicting the neighboring block). In an example, the determination is made to obtain the second prediction block in response to determining that the current block and the neighboring block have (i.e., are predicted using) the same reference frame(s). As such, in this case, overlapped prediction is performed from the neighboring block using the common reference frames between the current block and the neighboring block.

That overlapped prediction is not performed (applied) from the neighboring block means that a prediction block for the current block is not obtained based on the motion information of the neighboring block and is not used (included) in obtaining a final prediction block for the current block.

In an example, the determination is made to obtain the second prediction block in response to determining that a motion-vector difference between the first motion vector and the second motion vector is smaller than a motion-vector threshold. In an example, the motion-vector threshold can depend on the distance between the first reference frame and the second reference frame. For example, the motion-vector threshold can be proportional to the frame distance. That is, the motion-vector threshold can be proportional to a temporal distance between the first reference frame and the second reference frame.

In an example, the motion-vector threshold can be less than or equal to n (i.e., “one-frame-distance-motion-vector threshold”) pixels per one-frame distance. In an example, n is equal to 16 pixels per one-frame distance. For example, assume that the first reference frame has a frame number of R and the second reference frame has a frame number of S, then the motion-vector threshold is calculated as n×|R−S|. In an example, the motion-vector difference between the first motion vector given by (MV_{x,1}, MV_{y,1}) and the second motion vector given by (MV_{x,2}, MV_{y,2}) can be calculated as \sqrt{(MV_{x,1}−MV_{x,2})²+(MV_{y,1}−MV_{y,2})²}. If the motion-vector difference is not smaller than 1 the motion-vector threshold, then overlapped prediction from the neighboring block may not be performed.

In an example, the one-frame-distance-motion-vector threshold may be decoded, at the decoder, from the compressed bitstream. As such, the motion-vector threshold can be obtained by decoding, from the compressed bitstream, the one-frame-distance-motion-vector threshold and calculating the motion-vector threshold based on (e.g., as a multiplication of) the one-frame-distance-motion-vector threshold and a frame difference between the first reference frame and the second reference frame. The one-frame-distance-motion-vector threshold may be signaled (e.g., encoded) in an SPS, a PPS, a slice header, a block header, or some other header. In another example, the one-frame-distance-motion-vector threshold may be predefined (e.g., pre-configured). When implemented at the encoder, the one-frame-distance-motion-vector threshold may be calculated by the encoder and encoded in the compressed bitstream 404 of FIG. 4.

In an example, if the first reference frame is different from the second reference frame, then the first motion vector and the second motion vector may be scaled to a target reference frame. The motion-vector difference is then calculated using the scaled first motion vector and the scaled second motion vector. As already mentioned, one or both of the current block and the neighboring block may be predicted using more than one motion vector.

Scaling the motion vectors can be generalized as follows. In response to determining that the current block is predicted using first motion vectors (e.g., more than one motion vector) that include the first motion vector, then scaled first motion vectors are obtained by scaling the first motion vectors to point to a target reference frame based on temporal distance. The scaled first motion vectors are then averaged to obtain a first normalized motion vector. Additionally, in response to determining that the neighboring block is predicted using second motion vectors (e.g., more than one motion vector) that include the second motion vector, then scaled second motion vectors are obtained by scaling the second motion vectors to point to the target reference frame based on the temporal distance. The scaled second motion vectors are then averaged to obtain a first normalized motion vector. The motion-vector difference is then obtained based on 1) one of the first normalized motion vector (if calculated) or the first motion vector (if the first normalized motion vector is not calculated) and 2) one of the second normalized motion vector (if calculated) or the second motion vector (if the second normalized motion vector is not calculated).

As such, the motion-vector threshold can be directly based on (e.g., compared to) normalized motion vectors. To illustrate, the normalized motion vectors for the bottom neighboring block and the current block may be MV_{n_B} and MV_{n_C}, respectively. If |MV_{n_B}−MV_{n_B}|>threshold (i.e., the motion-vector threshold), then overlapped prediction from bottom neighboring block is not applied.

Scaling a motion vector is now described. Assume that the current block is a block of a current frame having a temporal index C₀, that the motion vector (MVₓ, MV_{y}) of the block points to a reference frame having a temporal index R₁ and that the motion vector is to be scaled to a target reference frame having a temporal index R₂. Assume further that the distance between C₀ and R₁ is b (i.e., b=|C₀−R₁|); and that the distance between C₀ and R₂ is d(d=|C₀−R₂|). Thus, the scaled motion (MV_{x,scaled}, MV_{y,scaled}) can be obtained using MV_{x,scaled}=b/d MVₓ and MV_{y,scaled}=b/d MV_{y}.

In another example, the determination to obtain the second prediction block of at least a portion of the current block using an overlapped prediction mode that uses a second reference frame and a second motion vector of a neighboring block is made based on a determination that reference samples required for interpolation are available. Thus, if the reference samples required for interpolation are not available, then the overlapped prediction mode is not performed for the current block.

To illustrate, if the second motion vector includes a fractional portion (i.e., refers to a subpixel location), then the subpixel values are obtained via interpolation using an interpolation filter. Assuming that the interpolation filter has T taps and that the current block is of size M×N, then a reference block that is larger than M×N would be required to generate the second prediction block. The reference block size would have to have a size of (M+T−1)×(N+T−1). The top-left block corner of the reference block can be given by the integer pixel at location (MVₓ−(T/2−1), MV_{y}−(T/2−1)) where (MVx, MV_{y}) is the second motion vector for the reference block. Thus, to restate, the determination to obtain the second prediction block is made in response to determining that the reference samples of the reference sample block having a size of (M+T−1)×(N+T−1) are available.

In an example, the determination to obtain respective second prediction blocks for different boundaries of the current block can be made in parallel. Stated another way, the determination on whether overlapped prediction is to be applied to different boundaries may be generated in parallel. In this situation, the first prediction block obtained at 1110 can be the first prediction block of the parent block that includes the current block. The parent block is the block of which the current block is a sub-block. To be more specific, the first prediction block can be the portion of the prediction block of the parent block where the portion corresponds to (e.g., is co-extensive with) the current block. The prediction block of the parent block is referred to herein as an “original prediction block.”

Referring to FIG. 7, and for convenience, the original prediction (or, equivalently, the original reference samples used to obtain the original prediction) for a parent block 735 may be referred to as P735. For the boundary (i.e., for the sub-blocks along the boundary) between the parent block 735 and the adjacent block 724, the prediction samples (or the reference samples therefor) along with motion vectors of the adjacent block 724 and P735 can be checked as described herein; and for the boundary between the adjacent block 721 and parent block 735, the prediction samples (or the reference samples) along with motion vectors of the adjacent block 721 and P735 are also checked as described herein. As P735 is used with respect to each of the boundaries, the overlapped prediction decision on (i.e., where to perform overlapped predictions with respect to sub-blocks along) different boundaries may be made in parallel. In the case that the parent block 735 is bi-predicted, either the result of bi-prediction or the average of the two reference sample blocks used for the bi-prediction may be used.

As such, the technique 1100 can determine, in parallel with determining whether to obtain the second prediction block of the at least the portion of the current block using the overlapped prediction mode, whether to perform the overlapped prediction mode with respect to a second boundary of the parent block, wherein the second boundary is different from the first boundary. In an example, the determination to perform overlapped prediction can be performed for each boundary, as a whole, of the parent block in parallel.

At 1130, the second prediction block is obtained using the overlapped prediction mode. At 1140, the first prediction block and the second prediction block are combined. Combining the first prediction block and the second prediction block can mean including the first prediction block and the second prediction in one or more calculations that result in obtaining a final prediction block for the current block.

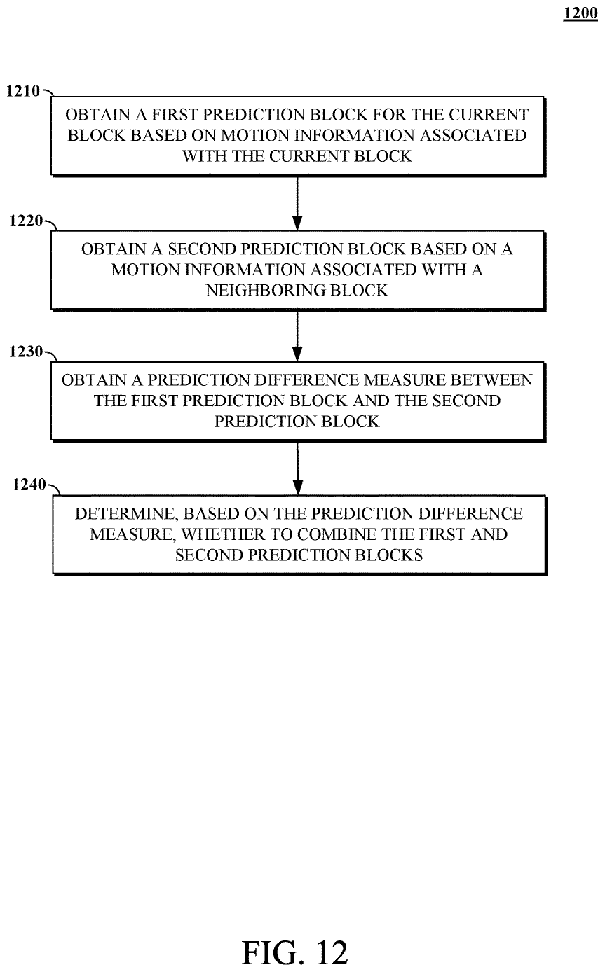

FIG. 12 is a flowchart diagram of another technique 1200 for coding a current block of a video frame using overlapped prediction. The technique 1100 can be implemented, for example, as a software program that may be executed by computing devices such as one or more of the computing and communication devices 100A/100B/100C for FIG. 2. The software program can include machine-readable instructions that may be stored in a memory, such as the memory 150 of FIG. 1, and that, when executed by a processor, such as the processor 140 of FIG. 1, may cause the computing device to perform the technique 1200. The technique 1200 may be implemented in whole or in part by the intra/inter prediction unit 540 of the decoder 500 of FIG. 5. The technique 1100 may be implemented in whole or in part by the intra/inter-prediction unit 410 of the encoder 400 of FIG. 4. The technique 1200 can be implemented using specialized hardware or firmware. Multiple processors, memories, or both, may be used.

The technique 1200 determines whether to apply overlapped prediction from a particular neighboring block based on a prediction difference between predicted samples of the current block and a prediction of the current block based on the motion information (e.g., motion vector(s)) of the particular neighboring block. In an example, the prediction difference can be a sum of absolute differences (SAD). In another example, the prediction difference can be the sum of squared error (SSE). However, other measures are possible for the prediction difference, as further described herein.

At 1210, a first prediction block is obtained for the current block based on motion information associated with the current block. The motion information associated with the first block may be on include one or more motion vectors and respective one or more reference frames. At 1220, a second prediction block for at least a portion of the current block is obtained based on motion information associated with a neighboring block. The motion information associated with a neighboring block can be on include one or more motion vectors and respective one or more reference frames.

At 1230, a prediction difference measure between the first prediction block and the second prediction block is determined. The prediction difference measure is calculated as a function of pair-wise differences between the values of the first prediction block and the values of the second prediction block. As already mentioned, the prediction difference measure can be the SAD, the SSE, or some other measure.

In an example, the prediction difference measure can be the absolute maximum of the pair-wise differences between the first prediction block and the second prediction block. In another example, the prediction difference measure can be obtained as the absolute difference between the maximum absolute difference and the average absolute difference. The maximum absolute difference is the absolute maximum of the pair-wise differences between the first prediction block and the second prediction block; and the average absolute difference is the average of the pair-wise differences between the first prediction block and the second prediction block. In another example, the prediction difference measure is calculated based on a ratio of the maximum absolute difference to the average absolute difference.

At 1240, a determination is made, based on the prediction difference measure, whether to combine the first prediction block and the second prediction block of the portion of the current block. In an example, if the prediction difference measure exceeds a threshold, then the second prediction block is not included in the overlapped prediction for the current block. In an example, the threshold may be signaled (e.g., encoded) in an SPS, a PPS, a slice header, a block header, or some other header. In an example, and to simplify hardware implementation of the technique 1200, the threshold can be a power of 2 (e.g., 2⁷=128). In an example, the threshold may be adjusted or scaled based on the bit-depth of the encoding/decoding. To illustrate, assume a base threshold T (e.g., T=128) and a bit-depth of d bits per pixel (e.g., d=10 bits), then the threshold can be calculated as 2^{(d-8)}T. In an example, the base threshold can be signaled.

As described with respect to the technique 1100, in some examples, the technique 1200 is determined to be performed with respect to the neighboring block if certain conditions apply (i.e., are satisfied). In an example, the second prediction block is obtained in response to determining that a motion-vector difference between a first motion vector of the current block and a second motion vector of the neighboring block is smaller than a motion-vector threshold. In an example, the second prediction block is obtained in response to determining that first reference frames used for predicting the current block are at least partially the same as second reference frames used for predicting the neighboring block are the same. In an example, the second prediction block is obtained in response to determining that the current block is a block of a P frame or a P slice, that the current block and the neighboring block use the same reference frames, and that respective absolute motion vector differences between motion vectors of the current block and motion vectors of the neighboring block are below a motion-vector threshold. In another example, a conforming bitstream constraint can be applied to disallow overlapped prediction in P slices.

For simplicity of explanation, the techniques 600, 1100, and 1200 of FIGS. 6, 11, and 12, respectively, are depicted and described as respective series of steps. However, steps in accordance with this disclosure can occur in various orders, concurrently, and/or iteratively. Additionally, steps in accordance with this disclosure may occur with other steps not presented and described herein. Furthermore, not all illustrated steps may be required to implement a technique in accordance with the disclosed subject matter.

The words “example” or “exemplary” are used herein to mean serving as an example, instance, or illustration. Any aspect or design described herein as “example” or “exemplary” not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. As used herein, the terms “determine” and “identify”, or any variations thereof, includes selecting, ascertaining, computing, looking up, receiving, determining, establishing, obtaining, or otherwise identifying or determining in any manner whatsoever using one or more of the devices shown in FIG. 1.

The implementations of computing and communication devices, such as one or more of the computing and communication devices 100A/100B/100C (and the algorithms, techniques, methods, instructions, etc. stored thereon and/or executed thereby), can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the computing and communication devices 100A/100B/100C do not necessarily have to be implemented in the same manner.

Further, in one implementation, for example, a computing and communication device can be implemented using a computer program that, when executed, carries out any of the respective methods, algorithms and/or instructions described herein. In addition, or alternatively, for example, a special purpose computer/processor can be utilized which can contain specialized hardware for carrying out any of the methods, algorithms, or instructions described herein.

A computing and communication device can, for example, be implemented on computers in a real-time video system. Alternatively, on computing and communication device (e.g., the computing and communication device 100A) can be implemented on a server and another computing and communication device (e.g., the computing and communication device 100B) can be implemented on a device separate from the server, such as a hand-held communications device.

Further, all or a portion of implementations can take the form of a computer program product accessible from, for example, a tangible computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described implementations have been described in order to allow easy understanding of the application are not limiting. On the contrary, the application covers various modifications and equivalent arrangements included within the scope of the appended claims, which scope is to be accorded the broadest interpretation so as to encompass all such modifications and equivalent structure as is permitted under the law.

1. A method for coding a current block of a current frame, comprising:
obtaining a first prediction block for the current block based on motion information associated with the first prediction block;
obtaining a second prediction block for at least a portion of the current block based on a-motion information associated with a neighboring block;
obtaining a prediction difference measure between the first prediction block and the second prediction block; and
determining, based on the prediction difference measure, whether to combine the first prediction block and the second prediction block of the portion of the current block.

2. The method of claim 1, wherein determining, based on the prediction difference measure, whether to combine the first prediction block and the second prediction block of the portion of the current block comprises:
determining not to combine the first prediction block and the second prediction block in response to the prediction difference measure exceeding a threshold.

3. (canceled)

4. The method of claim 1, wherein the prediction difference measure is one of a sum of absolute differences (SAD) between the first prediction block and the second prediction block or a sum of squared errors (SSE) between the first prediction block and the second prediction block.

5. (canceled)

6. The method of claim 1, wherein the prediction difference measure is an absolute maximum of pair-wise differences between the first prediction block and the second prediction block.

7. The method of claim 1, wherein;
the prediction difference measure is calculated based on at least one of a maximum absolute difference or an average absolute difference,
the maximum absolute difference is an absolute maximum of pair-wise differences between the first prediction block and the second prediction block, and
the average absolute difference is an average of the pair-wise differences.

8. The method of claim 7, wherein the prediction difference measure is one of:
calculated as an absolute difference between the maximum absolute difference and the average absolute difference, or
calculated based on a ratio of the maximum absolute difference to the average absolute difference.

9. (canceled)

10. The method of claim 1, further comprising:
determining to obtain the second prediction block in response to one of:
determining that a motion-vector difference between a first motion vector of the current block and a second motion vector of the neighboring block is smaller than a motion-vector threshold;
determining that first reference frames used for predicting the current block are at least partially the same as second reference frames used for predicting the neighboring block; or
determining that the current block is a block of a P frame or a P slice, that the current block and the neighboring block use the same reference frames and that respective absolute motion vector differences between motion vectors of the current block and motion vectors of the neighboring block are below a motion-vector threshold.

11. (canceled)

12. (canceled)

13. A method for coding a current block of a current frame, comprising:
obtaining a first prediction block for the current block based on a first reference frame and a first motion vector;
determining, based at least in part on information related to a neighboring block of the current block, to obtain a second prediction block of at least a portion of the current block using an overlapped prediction mode that uses a second reference frame and a second motion vector of the neighboring block, wherein the second motion vector of the neighboring block is obtained by rounding, to an integer pixel position, a motion vector used to predict the neighboring block;
obtaining the second prediction block using the overlapped prediction mode; and
combining the first prediction block and the second prediction block.

14. The method of claim 13, wherein determining, based at least in part on the information related to the neighboring block of the current block, to obtain the second prediction block of the portion of the current block using the overlapped prediction mode comprises:
determining that a motion-vector difference between the first motion vector and the second motion vector is smaller than a motion-vector threshold.

15. The method of claim 14, further comprising:
decoding, from a compressed bitstream, a one-frame-distance-motion-vector threshold; and
calculating the motion-vector threshold based on the one-frame-distance-motion-vector threshold and a frame difference between the first reference frame and the second reference frame.

16. The method of claim 14, wherein the motion-vector threshold is proportional to a temporal distance between the first reference frame and the second reference frame.

17. The method of claim 14, further comprising:
in response to determining that the first reference frame is different from the second reference frame, calculating a difference between the first motion vector and the second motion vector by:
in response to determining that the current block is predicted using first motion vectors that include the first motion vector:
obtaining scaled first motion vectors by scaling the first motion vectors to point to a target reference frame based on a temporal distance; and
averaging the scaled first motion vectors to obtain a first normalized motion vector;
in response to determining that the neighboring block is predicted using second motion vectors that include the second motion vector:
obtaining scaled second motion vectors by scaling the second motion vectors to point to the target reference frame; and
averaging the scaled second motion vectors to obtain a second normalized motion vector; and
calculating the motion-vector difference based on 1) one of the first normalized motion vector or the first motion vector and 2) one of the second normalized motion vector or the second motion vector.

18. The method claim 13, wherein determining, based at least in part on the information related to the neighboring block of the current block, to obtain the second prediction block of the portion of the current block using the overlapped prediction mode comprises one of:
determining that first reference frames used for predicting the current block are at least partially the same as second reference frames used for predicting the neighboring block, wherein the first reference frames include the first reference frame and the second reference frames include the second reference frame, and wherein the first reference frame is the same as the second reference frame;
determining that reference samples used to obtain the second prediction block using a subpixel interpolation filter are available; or
determining that the current block is a block of a P frame or a P slice, that the current block and the neighboring block use the same reference frames, and that respective absolute motion vector differences between motion vectors of the current block and motion vectors of the neighboring block are below a motion-vector threshold.

19. (canceled)

20. (canceled)

21. The method of claim 13, where the motion vector used to predict the neighboring block is rounded using at least one of rounding toward positive infinity, rounding towards negative infinity, or rounding towards zero.

22. The method of claim 21, wherein a component of the motion vector is rounded towards positive infinity in a case that the component is positive, and the component of the motion vector is rounded towards negative infinity in a case that the component is negative.

23. The method of claim 13, wherein the current block is along a first boundary of a parent block, further comprising:
determining, in parallel with determining whether to obtain the second prediction block of the at least the portion of the current block using the overlapped prediction mode, whether to perform the overlapped prediction mode with respect to a second boundary of the parent block, wherein the second boundary is different from the first boundary.

24. A device, comprising:
a processor that is configured to perform the method of claim 1.

25. (canceled)

26. (canceled)

27. A non-transitory computer-readable storage medium having stored thereon an encoded bitstream, wherein the encoded bitstream is configured for decoding by the method of claim 1.

28. (canceled)

29. A device, comprising:
a processor that is configured to perform the method of claim 13.

30. (canceled)

31. (canceled)

32. A non-transitory computer-readable storage medium having stored thereon an encoded bitstream, wherein the encoded bitstream is configured for decoding by the method of claim 13.

33. (canceled)
